(19) United States
(12) Patent Application Publication
(10) Pub. No.: US 2007/0223532 A1
(43) Pub. Date: Sep. 27, 2007

(54) Method and system for data processing

(75) Inventor: Hee Chang Hwang, Anyang-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/723,710

(22) Filed: Mar. 21, 2007

(30) Foreign Application Priority Data
Mar. 23, 2006 (KR) 10-2006-0026316

(51) Int. Cl. H04J 3/16

(52) U.S. Cl. 370/469; 370/412

(57) ABSTRACT

A method and system for processing data between communication protocol layers are discussed. According to an embodiment, a memory is formed in a data link layer to store data received from a lower layer and to transmit the stored data to an upper layer, so that a data loss due to a data processing difference between different layers can be prevented.

### CROSS REFERENCE TO RELATED APPLICATION

This application claims priority to Korean Patent Application No. 10-2006-0026316 filed on Mar. 23, 2006, which is incorporated herein by reference.

### BACKGROUND OF THE INVENTION

1. Field of the Invention

The present disclosure relates to a method and system for processing data between communication protocol layers.

2. Description of the Related Art

Generally, a protocol defining a process for transmitting and receiving data in a communication system allows data to be transmitted and received according to predetermined rules.

A communication protocol includes a plurality of layers. Data may be overwritten and lost due to a transmission process difference between a logical link control (LLC) sublayer and a media access control (MAC) sublayer formed in a data link layer (DLL) of the plurality of layers.

For example, when a time for which data are received from the MAC layer (lower layer) is faster than a time for the LLC sublayer to process the data received from the MAC sublayer and transmit the received data to an upper layer, e.g., a network layer, data may be overwritten and lost, which is a problem.

Therefore, in the case where the received data are data that should be completely transmitted, a communication system according to the related art has the above mentioned (data error) problem arising due to the transmission process difference between the LLC sublayer and the MAC sublayer, and has no technique to deal with such data error problem.

### SUMMARY OF THE INVENTION

Accordingly, the present disclosure is directed to a method and system for processing data that substantially obviates one or more problems due to limitations and disadvantages of the related art.

According to one general implementation, there is provided a method for processing data in a communication system, capable of preventing data from being lost while it is processed by providing a memory to a predetermined layer of a communication protocol, e.g., an LLC sublayer of a data link layer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to another general implementation, there is provided a method for processing data in transmitting data through a plurality of layers, the method including: storing data received from a lower layer in a buffer memory set in a predetermined layer; and transmitting the stored data to an upper layer.

According to another aspect, the present invention provides a method for processing data in transmitting data through a plurality of layers, the method comprising: storing, in a buffer memory provided in a first sublayer of one of the layers, data received from a second sublayer of the one layer; and transmitting the stored data from the first sublayer to an upper layer above the one layer.

According to another aspect, the present invention provides a method for controlling transmission of data, the method comprising: determining an amount or number of data to be transmitted to an upper layer of a data link layer on the basis of one of a processing amount and a processing speed of a logical link control sublayer of the data link layer; and setting a memory in the logical link control sublayer based on the determination result.

According to another aspect, the present invention provides a method for processing data at a logical link control layer of a communication protocol, the method comprising: setting a ring buffer in the logical link control layer for temporarily storing data in response to a control message; sequentially storing received data in the ring buffer; and judging whether the received data are transmittable to an upper layer, and transmitting the data stored in the ring buffer to the upper layer based on the judging result.

According to another aspect, the present invention provides a communication protocol structure for processing data, the structure comprising: a data link layer (DLL) including a logical link control (LLC) sublayer and a medium access control (MAC) sublayer; and an upper layer, above the DLL, for receiving data from the LLC sublayer, wherein the DLL receives a first service primitive for setting a memory in the LLC sublayer and sets the memory in the LLC sublayer according to the first service primitive.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating layers for transmitting and receiving data in a communication system according to an embodiment of the present invention;

FIG. 2 is a view illustrating an example of a DLL in which a memory buffer is provided and a related layer thereof according to an embodiment of the present invention;

FIG. 3 is a view illustrating an example of a ring buffer according to an embodiment of the present invention;

FIG. 4 is a flowchart explaining an operation of setting, at an LLC sublayer, a ring buffer according to an embodiment of the present invention;

FIG. 5 is a block diagram illustrating an example of a ring buffer managed by an LLC sublayer according to the present invention; and

FIG. 6 is a flowchart illustrating a method of processing data through a ring buffer of an LLC sublayer according to an embodiment of the present invention.

### DETAILED DESCRIPTION OF THE PREFERRED EMBODIMENTS

Reference will now be made in detail to the embodiments of the present disclosure, examples of which are illustrated in the accompanying drawings. In a method for processing data in a communication system according to the present invention, a memory is set in an LLC sublayer of a data link layer, and a data amount or the number of data is sequentially transmitted to a network layer (an upper layer) on the basis of a processing amount or a processing speed of the LLC sublayer. As a result, loss or overwriting of data in association with the LLC sublayer can be effectively minimized or prevented.

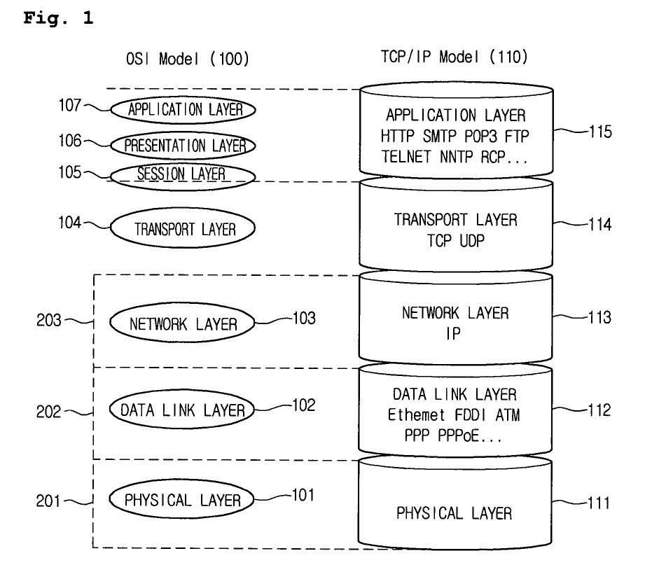

FIG. 1 is a view illustrating layers for transmitting and receiving data in a communication system according to an embodiment of the present invention.

Referring to FIG. 1, in the communication system according to the present invention, data transmission and reception can be performed through an OSI (open system interconnect) model 100 or transmission control protocol (TCP)/Internet protocol (IP) model 110.

In the first example, the OSI model 100 defines seven layers in order to perform communication. Since the layers are independent of one another, the communication system can design a protocol suitable for a standard defined by each layer and perform communication even when types of computers are different.

The seven layers of the OSI model 100 include a physical layer 101, which a lowermost layer, a data link layer (DLL) 102, a network layer 103, a transport layer 104, a session layer 105, a presentation layer 106, and an application layer 107, all operatively configured. Each of the layers 101-107 performs predetermined function(s), and directly communicates with the layer directly above it and the layer directly below it.

In an embodiment of the present invention, the DLL 102 of the seven layers of the OSI is dealt as a primary technical field. The DLL 102 is located above the physical layer 101 to check whether the physical layer 101 properly performs a data transmission/reception function.

That is, the DLL 102 addresses problems that may be generated during data transmission to allow a reliable data transmission function to be achieved between adjacent communication systems. Also, an example, a DLL in a controller area network (CAN) defined by ISO 11898-1 regulations, which fall within the technical field of the present invention and is encompassed by the present invention, includes an MAC sublayer and an LLC sublayer. Particularly, the LLC sublayer does not define processing data received in the MAC sublayer and define only the service of transmitting the data to an upper layer.

According to a related art, the layers below the MAC sublayer use a CAN control chip formed of hardware, and the layers above the LLC sublayer are formed of software. As a result, data are received by the LLC sublayer (which is a software terminal) fast from the MAC sublayer, which is a hardware terminal, and the LLC sublayer needs to process the received data quickly, but is not able to. Accordingly, data transmission in the related art may not be swiftly performed due to the data processing delay.

To address these limitations, the present invention provides a buffer or memory such as a ring buffer (300 in FIG. 3) in the LLC sublayer of the DLL so that the received data can be selectively stored and transmitted as needed to the upper layer without the loss and/or overwriting of the received data.

The present invention can be applied to either the OSI model 100 or the TCP/IP model 110 through which data transmission/reception can be performed. Also the layers shown in FIG. 1 can be embodied on at least one computer-readable medium, which can be hardware (e.g., hard drive, optical disc, ROM, etc.), software, or a combination of the hardware and software.

The substantial function(s) of the TCP/IP model 110 are similar to those of the OSI model 100. As shown in FIG. 1, the TCP/IP model 110 includes a physical layer 111, which a lowermost layer, a DLL 112, a network layer 113, a transport layer 114, and an application layer 115, all operatively configured. Each of these layers performs predetermined function(s), and directly communicates with the layer directly above it and with the layer below it.

A reference numeral 201 is used to refer to the physical layer 101 and/or 111; a reference numeral 202 is used to refer to the DLL 102 and/or 112; and a reference numeral 203 is used to refer to the network layer 103 and/or 113.

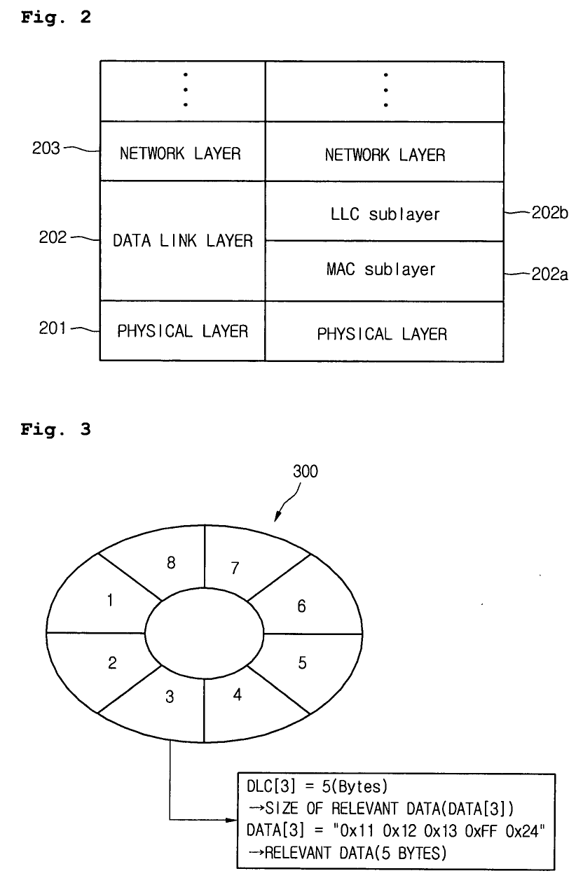

FIG. 2 is a view illustrating a DLL in which a memory buffer is provided and a related layer thereof according to an embodiment of the present invention.

Referring to FIG. 2, a physical layer 201, the DDL 202, and a network layer 203 are illustrated. As mentioned above, the physical layer 201 can represent the physical layer 101 in the OSI model or the physical layer 111 in the TCP/IP model; the DLL 202 can represent the DLL 102 in the OSI model or the DLL 112 in the TCP/IP model; and the network layer 203 can represent the network layer 103 in the OSI model or the network layer 113 in the TCP/IP model. Also, the present invention is not limited to the OSI model or the TCP/IP model, but can be applied to other models having the DLL type layer,

The DLL 202 includes an LLC (logical link control) sublayer 202b in which a memory buffer is formed, and an MAC sublayer 202a for transmitting data received from the physical layer 201 to the LLC sublayer 202b.

In the communication system including the communication layer having the above-described structure, the present invention provides a method for processing data in the communication system to achieve data processing without loss at the LLC sublayer of the DLL. The above-described structure is one embodiment.

According to an embodiment of the present invention, a ring buffer, which is one type of a memory, is added to the LLC sublayer 202b of the DLL 202 to prevent data loss. A service primitive allowing the ring buffer to be added to ISO 11989-1 prescribing the LLC sublayer service and allowing the ring buffer to be used should be set.

The service primitive is a means for delivering all data received from a lower layer to an upper layer without loss. Of course, the service primitive can function in an opposite direction.

First, a service primitive for assigning and applying the ring buffer (or other memory in the LLC sublayer 202b) according to the present invention is formed as described blow:

L_Data.Status_Request(
Use_Ring_Buffer[USE/NOT_USE]
Buff_Max_Number[1...M])

According to the present invention, the L_Data.Status_Request service primitive is a command for setting the ring buffer such that the LLC sublayer uses or does not use the ring buffer. By this service primitive, ‘USE’ or ‘NOT_USE’ of ‘Use_Ring_Buffer’ is set, and a maximum ring buffer size is set using ‘Buff_Max_Number[1 . . . M]’.

The maximum buffer amount ‘Buff_Max_Number[1 . . . M]’ is different depending on the performance of the system to be used. That is, ‘Buff_Max_Number[1 . . . M]’ is variably set depending on the performance of the system. For example, in the case where there is no data transmission delay between an LLC sublayer and an upper layer (e.g., a network layer) in a predetermined system, the size of the buffer may be 1.

According to an embodiment, the ring buffer assigns 8 bytes per data. In the case where the system user (e.g., administrator) knows the time it takes for the LLC layer to process received data and deliver the processed data to an upper layer (e.g., the network layer 203), and the amount and/or the number of data continuously received from the MAC sublayer to the LLC sublayer within a predetermined time (e.g., the time it takes for the LLC sublayer to process data and deliver the processed data to the upper layer), the size of the ring buffer is assigned to reflect that time and the amount of data, so that the memory size can be saved and data loss can be prevented.

8 bytes per data means maximum bytes that can be accommodated in one frame, which is a unit received by the LLC sublayer.

Therefore, whether the ring buffer is required in the LLC sublayer and what the maximum buffer amount is can be indicated on the basis of the service primitive ‘L_Data.Status_Request’.

FIG. 3 is a view illustrating an example of a ring buffer 300 which can be included in the LLC sublayer 202b according to an embodiment of the present invention.

Referring to FIG. 3, the ring buffer 300 includes eight buffers. DLC(N) means DLC(N) for DATA[N], which is an N-th DATA.

The ring buffer setting at the LLC layer and the maximum buffer amount M setting (e.g., in ‘Buff_Max_Number[1 . . . M]’) using the above-described service primitive are performed as described below according to the present invention.

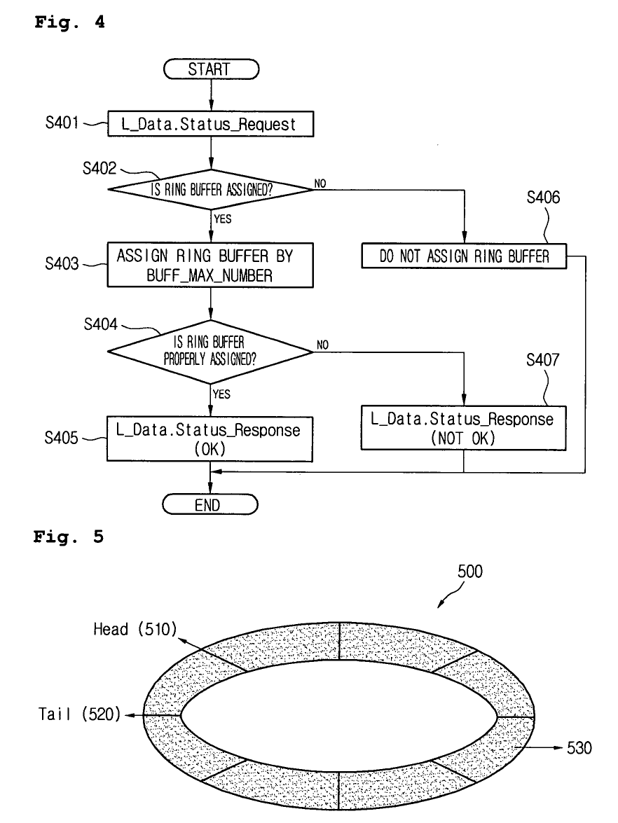

FIG. 4 is a flowchart explaining an operation of setting, at an LLC sublayer, a ring buffer according to an embodiment of the present invention. The method of FIG. 4 is discussed as being applied to the communication system of FIGS. 1-3, but is also applicable to other systems. Also, the method of FIG. 4 is not limited to using the ring buffer, but can utilize other types of memory or storage.

Referring to FIG. 4, the LLC sublayer (e.g., the LLC sublayer 202b) receives (S401) a message of ‘L_Data.Status_Request’ (e.g., from another entity in the system or outside the system), which is a service primitive defined in advance, and judges (S402) whether to use a ring buffer (e.g., the ring buffer 300) on the basis of the received message in order to form a ring buffer from the system and process data.

That is, when the content of ‘Use_Ring_Buffer’ is ‘USE’ in the above-described service primitive (e.g., ‘L_Data.Status_Request’), it is judged that the ring buffer is to be used (S403). On the other hand, when the content of ‘Use_Ring_Buffer’ is ‘NOT_USE’ in the above-described service primitive, it is judged that the ring buffer is not to be assigned/used (S406).

When it is judged that the ring buffer is to be assigned (used) at step S402, the LLC sublayer sets/assigns an amount (or size) of the ring buffer to correspond to ‘Buff_Max_Number’ (M) contained in the service primitive message. For instance, in the case where the system user knows the time it takes for the LLC sublayer to process data and deliver the processed data to an upper layer as described above, the buffer size (i.e., the size of the ring buffer) required for a minimum data loss is set accordingly so as to transmit data to the upper layer without data loss. On the other hand,t if the system user does not have such information, a memory size can be saved and a data loss can be prevented by assigning a minimum buffer size set in advance or assigning a minimum buffer size through tuning/negotiation.

The LLC sublayer transmits (S405 and S407) a response to the system depending on whether the ring buffer assigning using the received service primitive has been properly performed (S404)

At this point, in one example, the response is a service primitive ‘L_Data.Status_Response’ and has the following description:

```
L_Data.Status_Response(
      Set_Status[OK/NOT_OK]
      )
```

That is, in the case where the ring buffer assigning has been properly performed, a service primitive having a content of ‘Set_Status[OK]’ is transmitted to an entity in the system or outside the system which sent the message ‘L_Data.Status_Request’ (S405). On the other hand, in the case where the ring buffer assigning has not been properly performed, a service primitive having a content of ‘Set_Status[NOT_OK]’ is transmitted to the entity in or outside the system (S407).

In an example, whether or not the ring buffer has been properly assigned can be determined by judging whether the ring buffer is assigned by ‘Buff_Max_Number’ at ‘Set_Status[OK/NOT_OK]’.

In the case where the ring buffer is properly assigned from the LLC sublayer, data received by the LLC sublayer (e.g., from the MAC sublayer) are stored in the ring buffer and a service primitive is redefined (e.g., ‘L_Data.Indication’) and used in order to transmit the received data to an upper layer.

An example of a redefined service primitive of ‘L_Data.Indication’ is described below as follows:

```
L_Data.Indication(
        Identifier
        DLC[1]
        DATA[1]
        ...
        DLC[N]
        DATA[N]
        N
        )
```

When data are received from the MAC sublayer, the service primitive of ‘L_Data.Indication’ allows the received data to be sequentially stored in the ring buffer in the LLC sublayer of the present invention.

At this point, the number of data (frames) stored in the buffer (ring buffer in this example) corresponds to the number of transmissions at the MAC sublayer.

In the above service primitive, DLC (data length code)[N] is size data of an N-th data, and DATA[N] is actual N-th data. Also, the last N is the number of data to be transmitted to an upper layer (e.g., network layer) and is variable. That is, ‘N’ is the number of total data to be transmitted to the upper layer. Also, transmission to the upper layer sends all data currently contained in the ring buffer regardless of the number of data stored in the ring buffer when transmission can be made without delay.

Therefore, the number of data contained in the ring buffer that is transmitted to the upper layer at a point where transmission is possible can be 1, and can be N at the maximum.

A transmission point can be controlled by a controller of the system checking the states of the LLC sublayer and the network layer, or data can transmitted by a predetermined period. For example, a controller of the communication system or the LLC sublayer itself can control or implement the steps in the method of FIG. 4. The controller or the LLC sublayer can check the states of the LLC sublayer and the network layer at predetermined times or as needed.

Also, ‘identifier’ in the above service primitive of ‘L_Data.Indication’ is intended for informing the upper layer (e.g., the network layer) that where data are currently transmitted.

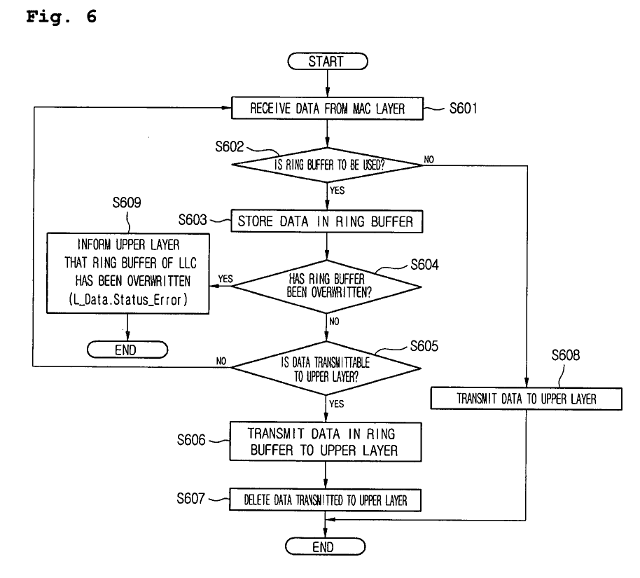

FIG. 5 is a block diagram illustrating an example of a ring buffer 500 managed by the LLC sublayer according to the present invention. The method of FIG. 4 can utilize the ring buffer 500.

Referring to FIG. 5, a head 510 and a tail 520, which are a start and an end of the ring buffer 500, respectively, are managed internally in the LLC sublayer. Data received by the LLC sublayer are stored in M data regions 530 of the buffer ring 500. The M data regions 530 are also managed internally in the LLC sublayer, and assigned such that M effective data are stored in the ring buffer 500. ‘Head’ is a place in which data is to be stored, ‘tail’ is a place from which data is to be read.

A process of storing, at the LLC sublayer, data in the ring buffer using a service primitive of redefined ‘L_Data.Indication’, and processing/transmitting the data is described below according to an embodiment of the present invention.

FIG. 6 is a flowchart illustrating a method of processing data through a ring buffer of an LLC sublayer according to an embodiment of the present invention. Here, the ring buffer can be the ring buffer 300 and/or 500, and the method can be implanted in the communication system of the present invention.

Referring to FIG. 6, when data are received from the MAC sublayer (e.g., sublayer 202a in FIG. 2), which is a lower layer (S601), the LLC sublayer (e.g., sublayer 202b in FIG. 2) checks whether the ring buffer has been currently set to be used (S602).

In the case where the LLC sublayer uses the ring buffer, data received by the LLC sublayer (e.g., from the MAC sublayer) are temporarily stored in the ring buffer (S603).

At this point, the ring buffer allows data to be sequentially stored from the ‘head’ to ‘tail’ of the ring buffer, so that latest data is stored in an N-th order. The detailed description of the ring buffer is made with reference to FIGS. 3 and 5 above.

Meanwhile, the controller (e.g., the system controller or the controller in the LLC sublayer) checks whether the ring buffer has been overwritten when the received data are stored in the ring buffer (S604).

When it is determined that the data are not overwritten as a result of the checking at step S604, the LLC sublayer checks whether the LLC sublayer is in a state that can transmit the data to an upper layer such as the network layer 203 (S605). If it is determined that the transmission to the upper layer is possible, the LLC sublayer transmits the data contained in the ring buffer to the upper layer (S606).

After the data are transmitted to the upper layer, a portion of the data stored in the ring buffer that has been transmitted to the upper layer is deleted, and next data received by the LLC sublayer are sequentially stored in the ring buffer or the like (S607).

Meanwhile, if it is determined that the ring buffer has been overwritten as a result of the checking in S604, s the upper layer and/or the LLC sublayer (S609) is informed that the ring buffer of the LLC sublayer has been overwritten, and an appropriate service primitive is transmitted. For instance, as described below, the following service primitive may be sent from the LLC sublayer to the upper layer:

```
L_Data.Status_Error (
        Identifier
        )
```

Also, if it is determined that the LLC sublayer is in a state that cannot transmit data to the upper layer as a result of the checking in S605, the LLC sublayer receives next data transmitted from the MAC sublayer (S601), and sequentially stores the received data in the ring buffer (S602 and S603). That is, the process returns from step S605 to step S601.

Accordingly, through the newly defined ring buffer setting and assigning and operations of processing redefined data, the LLC sublayer delivers the data received from the MAC sublayer to the upper layer while reducing the data loss in the present invention.

Therefore, according to the method and system for processing data of a DLL in the present invention, an LLC sublayer temporarily stores received data in a ring buffer or the like, so that a loss of data to be transmitted to an upper layer is reduced or eliminated.

The method for processing data of a DLL in the communication system according to an embodiment of the present invention can be applied to between other layers for communication, and a person of ordinary skill in the art would easily make another or varied embodiment by adding, deleting, and/or combining elements in the various embodiments discussed herein without departing from the scope of the present disclosure.

It will be apparent to those skilled in the art that various modifications and variations can be made in the present disclosure. Thus, it is intended that the present disclosure covers the modifications and variations of this invention provided they come within the scope of the appended claims and their equivalents.

What is claimed is:

1. A method for processing data in transmitting data through a plurality of layers, the method comprising:
storing, in a buffer memory provided in a first sublayer of one of the layers, data received from a second sublayer of the one layer; and
transmitting the stored data from the first sublayer to an upper layer above the one layer.

2. The method according to claim 1, wherein the buffer memory is set in the first sublayer of the one layer according to a setting command of at least one service primitive.

3. The method according to claim 2, wherein the at least one service primitive includes a first service primitive of ‘L_Data.Status_Request’, which includes data regarding whether the buffer memory is required in the first sublayer of the one layer, and/or a maximum buffer amount display data.

4. The method according to claim 2, wherein the at least one service primitive includes a second service primitive of ‘L_Data.Indication’, which includes data regarding the second sublayer for transmitting data, an identifier, data regarding an amount or number of data transmitted from the first sublayer to the upper layer, and N which is a number of total data to be transmitted to the upper layer.

5. The method according to claim 4, wherein the amount or number of the data transmitted from the first sublayer to the upper layer, is determined depending on a delay degree of transmission from the first sublayer to the upper layer.

6. The method according to claim 4, wherein the amount or number of the data transmitted from the first sublayer to the upper layer, is determined on the basis of a transmission processing difference between the first and second sublayers.

7. The method according to claim 1, further comprising:
judging whether or not assigning of the buffer memory in the first sublayer is appropriate.

8. The method according to claim 7, wherein the judging step determines whether a size of the buffer memory assigned to the first sublayer is appropriate on the basis of a transmission processing difference between the first and second sublayers.

9. The method according to claim 7, further comprising:
generating a response to the determination of whether the size of the buffer memory assigned to the first sublayer is appropriate, wherein the response is a service primitive of L_Data.Status_Response (Set_Status[OK/NOT_OK]).

10. The method according to claim 1, further comprising:
judging whether data stored in the buffer memory of the first sublayer is overwritten.

11. The method according to claim 10, wherein if the data stored in the buffer memory of the first sublayer is judged to be overwritten, the method further comprises:
informing the upper layer about the overwriting of the data in the first sublayer.

12. The method according to claim 11, wherein the overwriting of the data is informed using a service primitive of L_Data.Status_Error.

13. The method according to claim 1, wherein the first and second sublayers are respectively a logical link control (LLC) sublayer and a media access control (MAC) sublayer formed in a data link layer (DLL).

14. A method for controlling transmission of data, the method comprising:
determining an amount or number of data to be transmitted to an upper layer of a data link layer on the basis of one of a processing amount and a processing speed of a logical link control sublayer of the data link layer; and
setting a memory in the logical link control sublayer based on the determination result.

15. A method for processing data at a logical link control layer of a communication protocol, the method comprising:
setting a ring buffer in the logical link control layer for temporarily storing data in response to a control message;
sequentially storing received data in the ring buffer; and
judging whether the received data are transmittable to an upper layer, and transmitting the data stored in the ring buffer to the upper layer based on the judging result.

16. The method according to claim 15, wherein the control message comprises data regarding a size of the ring buffer and/or data regarding whether or not the ring buffer is set.

17. The method according to claim 15, wherein the control message is defined as a service primitive of L_Data.Status_Request.

18. The method according to claim 15, wherein the control message is controlled to perform:
setting whether the ring buffer is to be used; and
if the ring buffer is to be used, setting a size of the ring buffer.

19. The method according to claim 15, wherein a service primitive of L_Data.Indication is redefined in order to store the received data in the ring buffer and transmit the stored data.

20. The method according to claim 15, wherein the ring buffer comprises a head in which data is initially stored, and a tail in which data is last stored, and latest data are sequentially stored last.

21. The method according to claim 15, wherein the ring buffer is set to store M data according to the control message.

22. The method according to claim 15, further comprising:
deleting a portion of data stored in the ring buffer that has been transmitted to the upper layer, after the portion of data stored in the ring buffer has been transmitted to the upper layer.

23. A communication protocol structure for processing data, the structure comprising:
a data link layer (DLL) including a logical link control (LLC) sublayer and a medium access control (MAC) sublayer; and
an upper layer, above the DLL, for receiving data from the LLC sublayer,
wherein the DLL receives a first service primitive for setting a memory in the LLC sublayer and sets the memory in the LLC sublayer according to the first service primitive.

24. The structure according to claim 23, wherein the LLC sublayer receives a second service primitive for performing at least one operation of storing data received from the MAC sublayer in the set memory and transmitting the stored data to the upper layer, and performs the at least one operation according to the second service primitive.

25. The structure according to claim 23, wherein the first service primitive performs:
a function of defining whether the memory is to be used; and
a function of setting a size of the memory.

26. The structure according to claim 24, wherein the second service primitive is a service primitive of L_Data.Indication.

27. The structure according to claim 23, wherein the memory is a ring buffer defined to store N data starting from a head to a tail of the ring buffer.
